(19) United States
(12) Patent Application Publication
(10) Pub. No.: US 2013/0179840 A1
(43) Pub. Date: Jul. 11, 2013

(54) USER INTERFACE FOR MOBILE DEVICE

(71) Applicant: Airbiquity Inc., Seattle, WA (US)

(72) Inventors: Sheldon Fisher, Seattle, WA (US); Bheemrao Zhade, Seattle, WA (US)

(73) Assignee: Airbiquity Inc., Seattle, WA (US)

(21) Appl. No.: 13/735,932

(22) Filed: Jan. 7, 2013

Related U.S. Application Data
(60) Provisional application No. 61/584,631, filed on Jan. 9, 2012.

(51) Int. Cl. G06F 3/0484

(52) U.S. Cl. CPC G06F 3/04842
USPC 715/835

(57) ABSTRACT

Disclosed are features and characteristics of a user interface of a portable device having a touch-sensitive display screen. The interface may display a first screen display layout on the display screen, for example the first display screen layout showing a home screen of an application program executing on the device. A special indicator in the display is used to invoke a “window shade” operation. Responsive to a user touching the indicator, a second screen display layout is shown on the device, wherein the second display screen layout comprises at least one icon corresponding to an available menu option of the application program. Preferably, the transition from the first screen display layout to the second screen display layout, is animated so as to imitate lowering of a physical window shade. Swiping actions may be used to display additional icons or menu options of the executing application program.

### RELATED APPLICATIONS

This application is a non-provisional of U.S. Provisional Patent Application No. 61/584,631 filed Jan. 9, 2012 and incorporated herein by this reference.

### COPYRIGHT NOTICE

©2011-2012 Airbiquity Inc. A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR §1.71(d).

### TECHNICAL FIELD

This invention pertains to methods and apparatus for user interaction with a portable electronic device, sometimes called a user interface, MMI (man-machine interface) or GUI (graphical user interface, commonly pronounced “goo-ey”). The invention may be applied to various portable electronic devices, including without limitation a cell phone or smart phone, tablet computer, e-reader, etc.

### BACKGROUND OF THE INVENTION

Portable electronic devices, such as smart phones, tablets, and various other connected mobile devices, including but not limited to devices that have external communication capabilities (wireless telecom, WiFi, Bluetooth® wireless, etc.) are becoming ubiquitous. Further, dramatic improvements in processor speeds and capabilities, as well as memory speed, density and other characteristics, have enabled the use of thousands of different application programs or “Apps” on portable devices, notwithstanding the relatively small size of such devices. However, because of relatively small display screen size, an effective human interface becomes a challenge. The need remains for improvements in user interfaces for mobile devices.

### SUMMARY

The following is a summary of the present disclosure in order to provide a basic understanding of some aspects of the invention. This summary is not intended to identify key/critical elements of the invention or to delineate the scope of the invention. Its sole purpose is to present some concepts of the invention in a simplified form as a prelude to the more detailed description that is presented later.

In one aspect, the present user interface provides for improved interaction with an application program executing on a mobile device such as a smartphone. In an embodiment, the application (“App”) may have a plurality of different functions or menu options available to the user. In some embodiments, each function has a corresponding screen display layout or interface. Preferably, each menu option's respective screen display layout may occupy most or substantially all of the device display screen. We use the term “screen display layout” to refer to content that appears on the device display screen at a given time.

Some additional aspects of the present user interface include arrangements for viewing and selecting among the various different functions or menu options that may be available during execution of a given App. In an embodiment, upon selection of a function, the selected function user interface then occupies most or substantially all of the device display screen. In this way, available display screen “real estate” is maximized for each function or feature of the running application.

Additional aspects and advantages of this invention will be apparent from the following detailed description of preferred embodiments, which proceeds with reference to the accompanying drawings.

### BRIEF DESCRIPTION OF THE DRAWINGS

FIG. 1A is an illustration of an example of a screen display layout on a display screen of a portable device in which an electric vehicle (EV) application is running, the screen display layout in a first state.

FIG. 1B illustrates an example of a transition from a first screen display layout of FIG. 1A to a second screen display layout of FIG. 2.

FIG. 1C illustrates a second example of a transition from the first screen display layout of FIG. 1A to the second screen display layout of FIG. 2.

FIG. 2 illustrates an example of a second screen display layout, or a second state, in which a “window shade” has been invoked by a user to display a grid array of menu options available in the EV application.

FIG. 3 illustrates an example of the screen display layout of FIG. 2 shifted laterally to the left responsive to a finger gesture or swipe, so as to display additional menu options A,B,C of the EV application in the screen display layout.

FIG. 4 illustrates an example of the screen display layout of FIG. 2, shifted upward responsive to a finger gesture or swipe, so as to include additional menu options of the EV application, represented by icons D, E, F, G in the screen display layout.

### DETAILED DESCRIPTION OF PREFERRED EMBODIMENTS

A user interface, especially for smart phones and other portable electronic devices, features a drop down “window shade” feature that displays available menu selections for a currently running application program. In an embodiment, after the “window shade” appears (preferably animated so as to appear as moving down over the previous display content like a window shade), the display (the window shade apparent surface) may also implement a sliding window option.

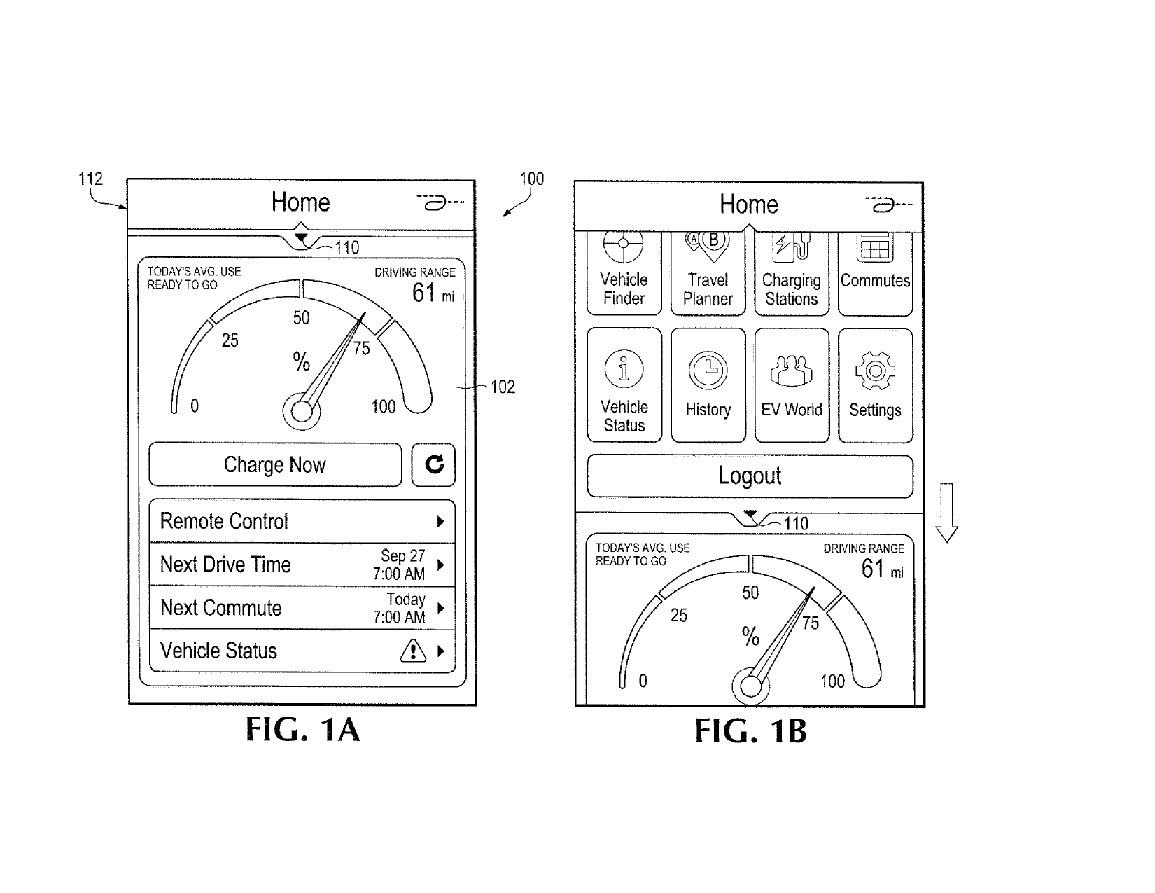

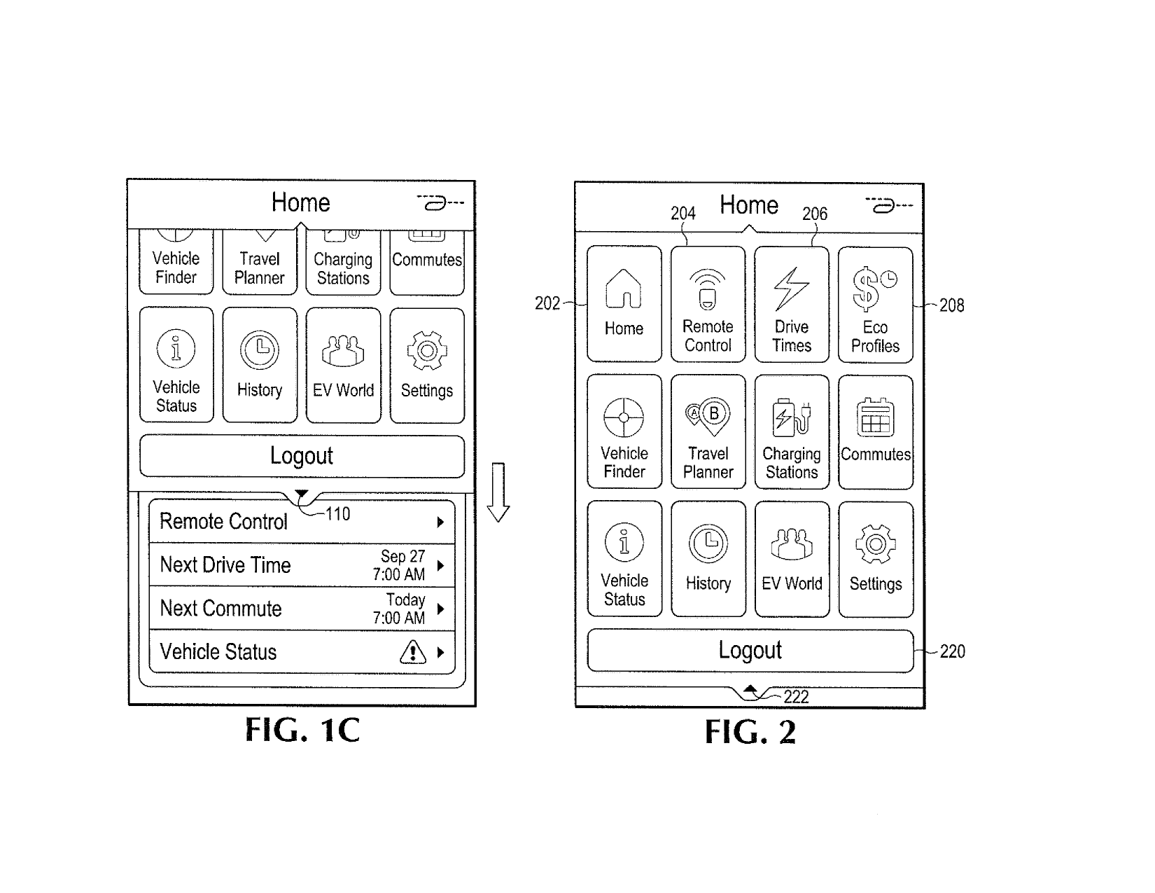

To illustrate, in one example, an application (or “app”) may be running on the device that supports managing use of a electric vehicle (EV), including charging, planning trips, etc. We'll call it an EV App. Referring now to FIG. 1A, it shows one example of a screen display layout on a display screen 102 of a portable device 100 in which the EV application is running. Here, the screen display layout is in a first state in which the “window shade” is not deployed, analogous to a physical shade in a “rolled up” state. Availability of the window shade function is suggested by the small triangle 110 situated below the word “Home” in the display screen layout. The triangle is merely illustrative and any other suitable symbol, icon, graphic or text may be used.

While running the EV App, a user might select (by a button, or screen touch) the home or main menu. In an embodiment, this may be done by selecting or touching an indicator near the top of the screen. For example, a downward-pointing triangle shape 110 or the like can provide a suggestive hint to a user that pressing that indicator will pull down the “window shade.” In response, the window shade is deployed, appearing to slide down over the device display screen.

The display screen layout shown in FIG. 1A is part of an EV App, showing present estimated driving range for an EV. The EV App is used here merely for illustration and not limitation. Many other apps, likely thousands of them, may benefit from implementing the user interface concept disclosed herein, as applied to the particular application at hand. A user may select (point, click, touch, etc) the top region 112 labeled “Home” or the down-triangle 110 (extends below the center of the Home bar) to deploy the window shade interface feature.

Preferably, the present user interface is implemented in software. Details of such software will be readily accessible to persons skilled in the art, in view of this disclosure, using modern software development libraries and tools. The present user interface can be used in conjunction with, or implemented in, almost any software application, especially on portable, wireless devices.

The window shade, when deployed, displays various menu options available in the EV application. One example is shown in FIG. 2. FIG. 2 shows virtual “buttons” for home 202, remote control 204, drive times 206, Eco profiles 208, and various other selections or menu options within the EV App. At the bottom, below the Logout bar 220, an upward-pointing triangle 222 or other indicator may be provided to raise the window shade, returning to the screen display as it appeared before the window shade was deployed, i.e. to a state of the type shown in FIG. 1.

FIG. 1B illustrates one example of a transition from the first display layout shown in FIG. 1A to a second layout shown in FIG. 2. Preferably, the transition is animated, to mimic pulling down a window shade over the display, in the direction shown by the adjacent arrow (top to bottom). In other embodiments, it may transition laterally or from bottom to top. In the example of FIG. 1B, the display layout of FIG. 1A “slides” downward on the display screen during the transition. Thus the “gas gauge” still appears just below the indicator 110. Menu option icons (e.g., “Vehicle Finder” “Travel Planner” etc.) move into view from the top of the display screen. In other embodiments, a different transition may be used. For example, in FIG. 1C, the display layout of FIG. 1A appears to remain in place, gradually covered over by the content of FIG. 2 display layout coming into view from the top of the display screen downward during the transition. Thus, in this example, the battery charge gauge is gone (seemingly covered up), while the lower portion of the layout of FIG. 1 remains in view, unchanged. Menu option icons (e.g., “Vehicle Finder” “Travel Planner” etc.) move into view as before.

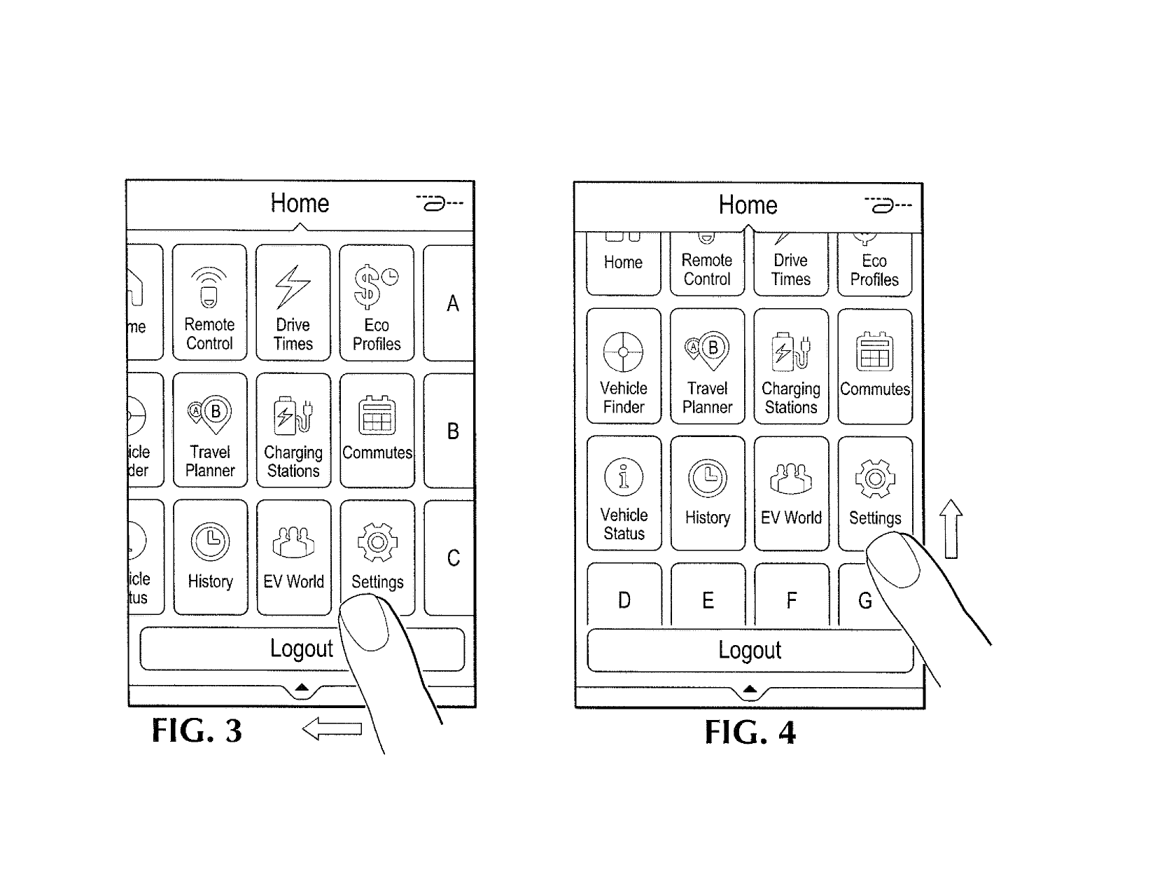

The embodiment of FIG. 2 shows a 4×3 grid array of 12 menu options. In some cases, more than 12 options may be needed, or the icons may be larger (or smaller). More display area may be needed. The rectilinear grid arrangement shown is merely illustrative, it is not critical. Icons need not be all the same size. In cases in which there are more options or menu items (represented typically by icons), the display layout may be configured to scroll or shift, horizontally, vertically, or both, to change the icons currently displayed. To illustrate, FIG. 3 shows a user, by finger touch (i.e., sliding the fingertip over the touch screen as indicated by the arrow shown below the device), scrolling the display horizontally to the left. This reveals additional menu icons (or buttons) labeled A, B and C coming into view from the right edge. Similarly, FIG. 4 illustrates sliding the display content upward, introducing menu items D, E, F and G coming into view from the bottom of the display screen.

It will be obvious to those having skill in the art that many changes may be made to the details of the above-described embodiments without departing from the underlying principles of the invention. The scope of the present invention should, therefore, be determined only by the following claims.

1. A method for user interface of a portable device having a touch-sensitive display screen, comprising:
displaying a first screen display layout on the display screen, wherein the first display screen layout comprises a home screen of an application program executing on the device;
in the first screen display layout, providing an indicator for a window shade operation;
responsive to a user touching the indicator, displaying a second screen display layout on the display screen, wherein the second display screen layout comprises at least one icon corresponding to an available menu option of the application program.

2. The method according to claim 1 and further comprising:
providing a second indicator in the second screen display layout for a reverse window shade operation; and
responsive to a user touching the second indicator, displaying substantially the first screen display layout on the display screen.

3. The method according to claim 2 and further comprising:
animating a transition from the first screen display layout to the second screen display layout, wherein the transition imitates lowering of a physical window shade.

4. The method according to claim 2 and further comprising:
animating a transition from the second screen display layout to the first screen display layout, wherein the transition imitates raising of a physical window shade.

5. The method according to claim 2 and further comprising;
animating a transition from the first screen display layout to the second screen display layout, wherein the transition comprises a lateral transition across the display screen.

6. The method according to claim 1 and further comprising:
responsive to a swipe of the display screen during display of the second screen display layout, transitioning from the second screen display layout to a third screen display layout, wherein the transitioning proceeds in a direction generally corresponding to a direction of the swipe, and wherein the third screen display layout comprises at least one additional icon corresponding to an available menu option of the application program that did not appear in the second screen display layout.

7. The method according to claim 6 and further comprising:
providing a third indicator in the third screen display layout for a reverse window shade operation; and
responsive to a user touching the third indicator, displaying substantially the first screen display layout on the display screen.

8. A memory device storing machine-executable instructions that, responsive to execution by a processor in a portable device having a touch-sensitive display screen, cause the processor to perform operations comprising:
displaying a first screen display layout on the display screen, wherein the first display screen layout comprises a home screen of an application program executing on the portable device;
in the first screen display layout, providing an indicator for a window shade operation;
responsive to a user touching the indicator, displaying a second screen display layout on the display screen, wherein the second display screen layout comprises at least one icon corresponding to an available menu option of the application program.

9. The memory device according to claim 8 and storing additional machine-executable instructions that, responsive to execution by the processor, cause the processor to perform operations comprising:
providing a second indicator in the second screen display layout for a reverse window shade operation; and
responsive to a user touching the second indicator, displaying substantially the first screen display layout on the display screen.

10. The memory device according to claim 9 and storing additional machine-executable instructions that, responsive to execution by the processor, cause the processor to perform operations comprising:
animating a transition from the first screen display layout to the second screen display layout, wherein the transition imitates lowering of a physical window shade.

11. The memory device according to claim 9 and storing additional machine-executable instructions that, responsive to execution by the processor, cause the processor to perform operations comprising:
animating a transition from the second screen display layout to the first screen display layout, wherein the transition imitates raising of a physical window shade.

12. The memory device according to claim 9 and storing additional machine-executable instructions that, responsive to execution by the processor, cause the processor to perform operations comprising:
animating a transition from the first screen display layout to the second screen display layout, wherein the transition comprises a lateral transition across the display screen.

13. The memory device according to claim 9 and storing additional machine-executable instructions that, responsive to execution by the processor, cause the processor to perform operations comprising:
responsive to a swipe of the display screen during display of the second screen display layout, transitioning from the second screen display layout to a third screen display layout, wherein the transitioning proceeds in a direction generally corresponding to a direction of the swipe, and wherein the third screen display layout comprises at least one additional icon corresponding to an available menu option of the application program that did not appear in the second screen display layout.

14. The memory device according to claim 9 and storing additional machine-executable instructions that, responsive to execution by the processor, cause the processor to perform operations comprising:
providing a third indicator in the third screen display layout for a reverse window shade operation; and
responsive to a user touching the third indicator, displaying substantially the first screen display layout on the display screen,

15. A portable electronic device comprising:
a processor;
a touch-sensitive display screen operatively coupled to the processor; and
memory operatively coupled to the processor, the memory storing machine-executable instructions that, responsive to execution in the processor, result in
displaying a first screen display layout on the display screen, wherein the first display screen layout comprises a home screen of an application program executing on the device;
in the first screen display layout, providing an indicator for a window shade operation; and
responsive to a user touching the indicator, displaying a second screen display layout on the display screen, wherein the second display screen layout comprises at least one icon corresponding to an available menu option of the application program.

16. The portable electronic device according to claim 15, wherein the memory stores additional machine-executable instructions that, responsive to execution by the processor, cause the processor to perform operations comprising:
providing a second indicator in the second screen display layout for a reverse window shade operation; and
responsive to a user touching the second indicator, displaying substantially the first screen display layout on the display screen.

17. The portable electronic device according to claim 15, wherein the memory stores additional machine-executable instructions that, responsive to execution by the processor, cause the processor to perform operations comprising: animating a transition from the first screen display layout to the second screen display layout, wherein the transition imitates lowering of a physical window shade.

18. The portable electronic device according to claim 15, wherein the memory stores additional machine-executable instructions that, responsive to execution by the processor, cause the processor to perform operations comprising:
animating a transition from the second screen display layout to the first screen display layout, wherein the transition imitates raising of a physical window shade.

19. The portable electronic device according to claim 15, wherein the memory stores additional machine-executable instructions that, responsive to execution by the processor, cause the processor to perform operations comprising:
responsive to a swipe of the display screen during display of the second screen display layout, transitioning from the second screen display layout to a third screen display layout, wherein the transitioning proceeds in a direction generally corresponding to a direction of the swipe; and
wherein the third screen display layout comprises at least one additional icon corresponding to an available menu option of the application program that did not appear in the second screen display layout.
